(19) United States
(12) Patent Application Publication
(10) Pub. No.: US 2007/0283400 A1
(43) Pub. Date: Dec. 6, 2007

(54) Method and apparatus for performing real-time on-line video quality monitoring for digital cable and IPTV services

(76) Inventors: Minkyu Lee, Ringoes, NJ (US); Wonsuck Lee, Basking Ridge, NJ (US)

Correspondence Address: Lucent Technologies Inc.;Docket Administrator - Room 3J216, 101 Crawfords Corner Road, Holmdel, NJ, 07733-3030, US

(21) Appl. No.: 11/444,345

(22) Filed: May 31, 2006

(51) Int. Cl. H04N 7/173

(52) U.S. Cl. 725/107; 725/105

(57) ABSTRACT

A method and apparatus for performing real-time on-line video quality monitoring for digital cable and IPTV (Internet Protocol Television) services, wherein a problem reporting button is advantageously provided on a (video service provider's) customer's set-top box and/or on a remote control unit therefor. Such a button may be advantageously used by the customer to report a video quality degradation problem to service providers. Illustratively, a single push of this button initiates the reporting process to report the existence of a problem regarding video quality which the customer is experiencing. The customer may indicate the severity of the problem with use of the button, and may also respond interactively to questions and or suggestions presented by the service provider on the video screen. Such an interactive troubleshooting procedure may be implemented as software on the set-top box.

### CROSS-REFERENCE TO RELATED APPLICATION

The present application is related to co-pending U.S. patent application Ser. No. ______, “Method For Real-Time Identification And Diagnosis Of Video Network Problems For Digital Cable And IPTV Service Providers,” filed by M. Lee and W. Lee on even date herewith and commonly assigned to the assignee of the present invention.

### FIELD OF THE INVENTION

The present invention relates generally to the field of digital cable and IPTV (Internet Protocol Television) services and more particularly to a method and apparatus for performing real-time on-line video quality monitoring therefor.

### BACKGROUND OF THE INVENTION

Emerging data communication and networking technologies based on the well-known Internet Protocol (IP) offer greater availability of broadband access to businesses and homes. This widely deployed broadband access offers many diversified and high quality video services to users. Delivering video over IP networks, such as IPTV (Internet Protocol Television) and enhanced digital cable, becomes an increasingly attractive solution to service providers as part of their combined product offerings of voice, data, and video.

Unlike, for example, traditional narrow band voice services or TCP protocol based data services, consumers' tolerance for poor quality video is limited as a result of the human visual system's powerful information processing capability. As such, the accurate monitoring of video quality is critical to the service provider's business. In particular, by monitoring video service quality in real time (i.e., as they are being provided), service providers can effectively prevent any further service degradation (when such degradation has been identified) and can, hopefully, solve any quality problems as soon as they occur.

In normal network operation, IP networks are subject to variety of possible impairments. These include, for example, packet loss and delay jitter. Although the ultimate goal of an IPTV service provider is to devise IP networks which deliver video of high and consistent quality, it is almost impractical to achieve such a guarantee given the nature of IP networks, despite the service provider's best efforts to maximize transmission quality. Thus, a continuous monitoring of the quality of transmitted video to the individual customer becomes the next best alternative.

In particular, a number of prior art, automated video quality assessment methods have been employed. These methods may be divided into two categories: i) “intrusive” methods, which, for example, compare the reconstructed video sequence at the receiver with the original video sequence at the sender, and ii) “non-intrusive” methods, which, for example, first measure a set of one or more network parameters, such as (for example) a measure of network packet losses, and then use these measured parameters to generate a video quality estimate. Such a video quality estimate may, for example, be derived according to well-known “loss-distortion models,” and may also incorporate application specific factors as well.

Unfortunately, methods in the former “intrusive” category are generally unsuitable for use in on-line monitoring, since they require the simultaneous availability of both the original video signal and the video signal as received by the customer. And methods in the latter “non-intrusive” category only provide a first-order approximation to measuring video quality, since they ignore the medium and the actual content information. In other words, the actual perceptual quality of a given video signal only correlates modestly to the measured network parameters, since the human visual system can compensate for some forms of video degradation far better than others. Moreover, these methods are invariably designed for a specific video codec (i.e., coding/decoding system), and thus may not be universally applicable for all video signals.

In summary, none of the prior art methods are sufficient to provide an effective mechanism for performing video quality assessment for use by cable TV or IPTV service providers. Thus, it would be advantageous to provide for a method which may be used by such service providers, and which advantageously assess the quality of a video signal in real-time, wherein the assessment of the video quality comprises an accurate reflection of the customer's perception thereof.

### SUMMARY OF THE INVENTION

We have recognized that, since the assessment of video quality is highly subjective in nature, the most accurate and useful method for performing video quality assessment is not only to make use of a human subject, but, moreover, to employ the customer himself or herself in real-time. Advantageously, if reporting a problem with the video quality is as simple as, for example, pushing a button, customers will be quite willing to make such a report, and willing to then wait to receive a better quality video signal, rather than, for example, calling (by telephone) the service provider's customer service organization in an attempt to resolve the problem. (Note, for example, that the idea of having users make a decision on a similarly highly subjective matter—namely, whether a given piece of email is spam or not—has been employed in the email industry with great success. Once a large group of users have identified a particular email as spam, it most likely is spam, and is so categorized by the email service provider as such.)

More specifically, in accordance with certain illustrative embodiments of the present invention, a problem reporting button is advantageously provided on a (video service provider's) customer's set-top box and/or on a remote control unit therefor. Such a button may be advantageously used by the customer to report a video quality degradation problem to service providers or their network management system. Illustratively, a single push of this button initiates the reporting process to report the existence of a problem regarding video quality which the customer is experiencing. In accordance with some of these illustrative embodiments of the invention, a few additional steps can be advantageously employed to refine the nature of the problem report, with the help of the customer, and potentially to resolve the problem in an interactive manner.

For example, in one illustrative embodiment of the invention, the customer may indicate the severity of the problem based on a number of pushes of the illustrative problem reporting button, or, alternatively, by pushing one of a plurality of problem reporting buttons. And in another illustrative embodiment of the invention, the customer may respond interactively to questions and or suggestions presented by the service provider on the video screen with various actions, which may include various pushes of the problem reporting button or pushes of various ones of the problem reporting buttons.

In particular, the present invention provides a method for reporting video quality problems of video signals received at a customer premises of a customer of a video service provider, the customer premises having located thereat a video display control apparatus for receiving and displaying said video signals, the method comprising the steps of (i) identifying that said video signals received from said video service provider and displayed at said customer premises are of insufficient quality as determined by said customer of said video service provider; and (ii) reporting said insufficient quality of said video signal to said service provider, wherein said reporting of said insufficient quality of said video signal is initiated by said customer with use of a user interface associated with said video display control apparatus.

The present invention also provides an apparatus for reporting video quality problems of video signals received at a customer premises of a customer of a video service provider, the apparatus located at the customer premises and comprising a video display control apparatus for receiving and displaying said video signals, the video display control apparatus including a user interface for use by said customer of said video service provider to initiate a report of insufficient quality of said video signal to said service provider.

### BRIEF DESCRIPTION OF THE DRAWINGS

FIG. 1 shows an example of a set-top box for receiving IPTV video signals and reporting video quality problems in accordance with an illustrative embodiment of the present invention.

FIG. 2 shows an example of a remote control for use with a set-top box for receiving IPTV video signals and reporting video quality problems in accordance with an illustrative embodiment of the present invention.

FIG. 3 shows a sample “question tree” flowchart of a method for performing video quality problem troubleshooting in accordance with an illustrative embodiment of the present invention.

### DETAILED DESCRIPTION OF THE PREFERRED EMBODIMENTS

In accordance with an illustrative embodiment of the present invention, a button is installed on a customer's set-top box and/or remote control unit therefor, the activation (e.g., pressing) of which may be advantageously used to report a video quality degradation problem to service providers or their network management system. Illustratively, a single push of the button initiates the reporting process, indicating that the customer is experiencing a video quality problem. In accordance with some illustrative embodiments of the present invention, and as described below, a few extra steps can be advantageously used to refine the problem definition with the help of the customer, to thereby obtain a subjective opinion of the nature of the problem. For example, the severity of the video degradation problem may, for example, be indicated by the customer based on, for example, a number of times the aforementioned button is pushed, and may respond interactively to questions and or suggestions presented by the service provider on the video screen

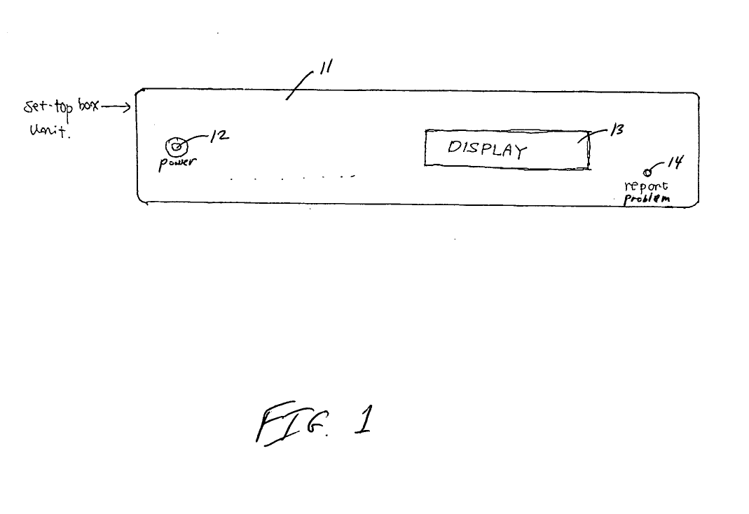

FIG. 1 shows an example of a set-top box for receiving IPTV video signals and reporting video quality problems in accordance with an illustrative embodiment of the present invention. The figure shows set-top box 11 having power button 12, display 13, and, in accordance with the illustrative embodiment of the present invention, video quality problem reporting button 14. Other buttons and other features which may be present on set-top box 11 are not explicitly shown in the figure. The set-top box of FIG. 1 advantageously provides a two-way communications capability between a service provider and the customer's premises.

In operation of the illustrative set-top box of FIG. 1, the customer (in whose premises set-top box 11 is located), may report to the service provider an indication of degraded video quality in the video content being received by the set-top box, simply by pressing video quality problem reporting button 14. In accordance with some illustrative embodiments of the present invention, video quality problem reporting button 14 may be further employed to provide more specific information regarding the video quality problem, and/or may be used in an interactive process to further define the nature of the video quality problem.

For example, the customer may use video quality problem reporting button 14 to report to the service provider not only the fact of a problem with the video quality, but also a (subjective) measure of the severity of video quality degradation being experienced. This may, for example, be reported by pressing the button a given number of times (e.g., from a minimum number of one to a maximum number, such as, for example, three) based on the perceived severity level. Moreover, the customer may respond interactively to questions and or suggestions presented by the service provider on the video screen with various actions, which may include various pushes of video quality problem reporting button 14.

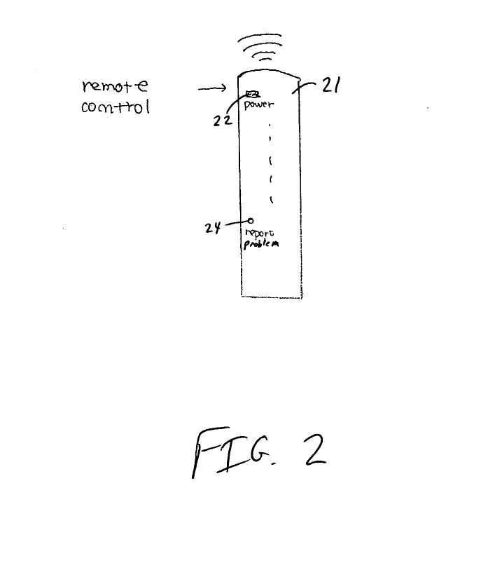

FIG. 2 shows an example of a remote control for use with a set-top box for receiving IPTV video signals and reporting video quality problems in accordance with an illustrative embodiment of the present invention. The figure shows remote control 21 having power button 22 and, in accordance with the illustrative embodiment of the present invention, video quality problem reporting button 24. Other buttons and other features which may be present on remote control 21 are not explicitly shown in the figure.

Note that the remote control of FIG. 2 may, for example, operate to control a set-top box (such as, for example, the set-top box of FIG. 1 or, alternatively, a conventional set-top box that does not have a video quality problem reporting button mounted thereon), or, it may operate to directly control a television or other video display device which has two-way communications capability between a service provider and the customer's premises, therefore having no need for a separate set-top box. As is well known to those skilled in the art, such televisions may, for example, be equipped with the capability to support the use of a “cable card.”

In operation of the illustrative remote control of FIG. 2, the customer (in whose premises a set-top box or television which is controlled by remote control 21), may report to the service provider an indication of degraded video quality in the video content being received by the set-top box, simply by pressing video quality problem reporting button 24. In accordance with some illustrative embodiments of the present invention, video quality problem reporting button 24 may be further employed to provide more specific information regarding the video quality problem, and/or may be used in an interactive process to further define the nature of the video quality problem, in similar fashion to the approaches described above in connection with the set-top box of FIG. 1.

In either of the illustrative embodiments shown in FIG. 1 or FIG. 2 (i.e., where a video quality problem reporting button is provided on a set-top box or a remote control unit), the operation of the illustrative devices (i.e., set-top box or remote control) may be supported with the use of embedded software contained within the set-top box (in the case of either FIG. 1 or FIG. 2), or, alternatively (in the case of FIG. 2 where no set-top box is provided) within a cable card. This embedded software advantageously operates to send bits of information back to the service provider, indicating the reporting of a video quality problem and/or specifying information related thereto. For example, the software may transmit to the service provider the customer's unique ID (identification) code, and, if available, an indication of the severity of video quality degradation (see above). (In other illustrative embodiments of the present invention, the above-described software may be located in whole or in part at the service provider's “head-end” rather than in the set-top box.) The implementation of such software will be obvious to those skilled in the art.

As pointed out above, in accordance with some illustrative embodiments of the present invention, an interactive process may be advantageously employed to further define the nature of the video quality problem which has been reported by the customer. For example, once the video quality problem reporting button has been pushed, a problem reporting process may be advantageously initiated in which, for example, the customer is first asked to choose between a number of possible common problems to identify the type of problem being experienced. Illustratively, the customer may be asked to choose from among:

(i) a scrambled or jerky picture;

(ii) macro blocking;

(iii) a frozen picture;

(iv) snow on all of the channels; etc.

### Then, based on the answer to this first question, a “question tree” may be traversed interactively with the user to narrow down the problem. (“Question trees” are fully familiar to those of ordinary skill in the art and are also known as “decision trees.”)

In accordance with one illustrative embodiment of the present invention, once the customer has chosen the type of the problem being experienced, the service provider may, for example, prompt the customer to indicate the severity of the problem. For example, the customer may be asked to rate the problem's severity on a scale between any two provided numbers, such as, for example, one and five, where one is defined to mean that the video signal is “merely acceptable” and five is defined to mean that the video signal is of “very poor quality.” The customer can confirm the severity of the problem report by responding appropriately to the query—such as, for example, with use of the video quality problem reporting button.

Next, in accordance with one illustrative embodiment of the present invention, the set-top box advantageously sends the information provided by the customer to the service provider's network management system, and the customer waits for an acknowledgement therefrom. The service provider's network management system may, in accordance with certain illustrative embodiments of the present invention, deduce certain causes of the customer's problem based on information provided by the customer as to the type of problem being experienced. For example, if it is identified that there is “snow” on all of the channels, it is possible that the cable or fiber optic cable line has been cut. In such a case, it may be necessary that the service provider's repair personal need to come to the customer's house to correct the problem. If, on the other hand, a scrambled picture box is identified, the problem is most likely with the customer's TV and set-top-box connection. In this case, for example, the following instructions may be given to the customer:

(i) check the TV's horizontal and vertical hold;

(ii) if the TV is connected to a VCR, try the following options:
a) Make sure the VCR is on channel 3,
b) Verify that the VCR is “fine-tuned” to channel 3,
(c) locate and adjust the fine-tuning until the picture comes in clearly,
(d) confirm that the 3/4 channel switch is in the correct position, 3; and

(iii) if a converter is connected to the TV, ensure that the TV is on channel 3.

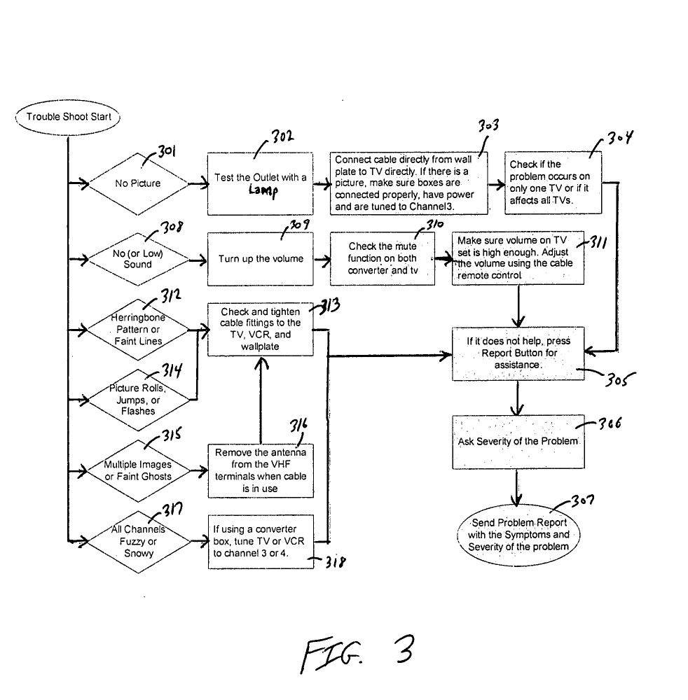

FIG. 3 shows a sample “question tree” flowchart of a method for performing video quality problem troubleshooting in accordance with an illustrative embodiment of the present invention. As pointed out above, this procedure may advantageously be implemented in software which resides, preferably, in the set-top box, but alternatively, at the head-end of the service provider's network.

Specifically, as shown in the sample flowchart, decision block 301 first asks the customer whether there is any picture at all. If not, the troubleshooting procedure suggests that the customer:

(i) test the outlet with a lamp (block 302),

(ii) connect the cable directly from the wall plate to the TV and, if there is a picture, make sure the boxes are properly connected, have power and are tuned to channel 3 (block 303), and

(iii) check if the problem occurs on only one TV if it affects all TV's (block 304).

Flow then proceeds to block 305, which instructs the customer to press the video quality problem reporting button (again) if the previous procedures did not help. Then, block 306 requests that the customer indicate the severity of the problem and block 307 sends the problem report with the symptoms and the severity of the problem to the service provider's network management system.

If the customer indicated in decision block 301 that there is, in fact, a picture, decision block 308 then asks if there is no (or low) sound. If not, the troubleshooting procedure suggests that the customer:

(i) turn up the volume (block 309),

(ii) check the mute function on both the converter and the TV (block 310), and

(iii) make sure that the volume on the TV set is high enough, and adjust the volume using the cable remote control (block 311).

Flow then again proceeds to block 305, which instructs the customer to press the video quality problem reporting button (again) if the previous procedures did not help. Then, block 306 requests that the customer indicate the severity of the problem and block 307 sends the problem report with the symptoms and the severity of the problem to the service provider's network management system.

If the customer indicated in decision block 308 that there is, in fact, sound, decision block 312 then asks if there are herringbone patterns or faint lines. If so, the troubleshooting procedure suggests that the customer check and tighten cable fittings to the TV, VCR and wall plate (block 313). Flow then again proceeds to block 305, which instructs the customer to press the video quality problem reporting button (again) if the previous procedures did not help. Then, block 306 requests that the customer indicate the severity of the problem and block 307 sends the problem report with the symptoms and the severity of the problem to the service provider's network management system.

If the customer indicated in decision block 312 that there is, in fact, no herringbone or faint line problem, decision block 314 then asks if the picture rolls, jumps or flashes. If so, the troubleshooting procedure again suggests that the customer check and tighten cable fittings to the TV, VCR and wall plate (block 313). Flow then again proceeds to block 305, which instructs the customer to press the video quality problem reporting button (again) if the previous procedures did not help. Then, block 306 requests that the customer indicate the severity of the problem and block 307 sends the problem report with the symptoms and the severity of the problem to the service provider's network management system.

If the customer indicated in decision block 314 that the picture does not, in fact, roll, jump or flash, decision block 315 then asks if there are multiple images or ghosts. If so, the troubleshooting procedure suggests that the customer remove the antenna from the VHF terminals of the TV when cable is in use (block 316). Flow then again proceeds to block 305, which instructs the customer to press the video quality problem reporting button (again) if the previous procedures did not help. Then, block 306 requests that the customer indicate the severity of the problem and block 307 sends the problem % report with <the symptoms and the severity of the problem to the service provider's network management system.

And finally, if the customer indicated in decision block 315 that there are no multiple images or ghosts, decision block 317 then asks if the picture on all channels is fuzzy or snowy. If so, the troubleshooting procedure suggests that, if the customer is using a converter box, that the TV or VCR be properly tuned to channel 3 or 4 (block 318). Flow then again proceeds to block 305, which instructs the customer to press the video quality problem reporting button (again) if the previous procedures did not help. Then, block 306 requests that the customer indicate the severity of the problem and block 307 sends the problem report with the symptoms and the severity of the problem to the service provider's network management system.

### Other Illustrative Embodiments

In accordance with other illustrative embodiments of the present invention, a “virtual” button, rather than a “physical” button, may be used to report video problems and/or to perform video quality problem troubleshooting. In particular, in a manner fully familiar to those of ordinary skill in computer-related arts, video monitor screens (such as, for example, those used by personal computers) often display a “virtual” “button” which may be activated with, for example, a mouse click or, alternatively, by being highlighted (possibly with use of a keyboard's “arrow” keys) followed by the pressing of a keyboard's “enter” key. Thus, in accordance with various other illustrative embodiments of the present invention, a “virtual” button may be displayed—either on the video screen which normally displays the video content or, alternatively, on any other associated display device—and the customer may activate this “virtual” button in any conventional manner available to report a video problem and/or to perform video quality problem troubleshooting.

Although the above illustrative embodiments of the present invention operate with the use of a single, “physical” problem reporting button on a set-top box or a remote control therefor, or with use of a single “virtual” problem reporting button on a television or computer monitor screen, it will be obvious to those of ordinary skill in the art that a plurality of physical or virtual buttons may be advantageously employed on those devices to provide additional flexibility and possibly additional functionality or ease of use. Thus, in accordance with other illustrative embodiments of the present invention, a plurality of problem reporting buttons—either “physical” or “virtual” or both—may be provided.

### Addendum to the Detailed Description

It should be noted that all of the preceding discussion merely illustrates the general principles of the invention. It will be appreciated that those skilled in the art will be able to devise various other arrangements, which, although not explicitly described or shown herein, embody the principles of the invention, and are included within its spirit and scope. In addition, all examples and conditional language recited herein are principally intended expressly to be only for pedagogical purposes to aid the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. It is also intended that such equivalents include both currently known equivalents as well as equivalents developed in the future—i.e., any elements developed that perform the same function, regardless of structure.

What is claimed is:

1. A method for reporting video quality problems of video signals received at a customer premises of a customer of a video service provider, the customer premises having located thereat a video display control apparatus for receiving and displaying said video signals, the method comprising the steps of:
identifying that said video signals received from said video service provider and displayed at said customer premises are of insufficient quality as determined by said customer of said video service provider; and
reporting said insufficient quality of said video signal to said service provider, wherein said reporting of said insufficient quality of said video signal is initiated by said customer with use of a user interface associated with said video display control apparatus.

2. The method of claim 1 wherein said video display control apparatus comprises a set-top box, wherein said user interface used to report said insufficient quality of said video signal to said service provider comprises a signaling device mounted on said set-top box, and wherein said step of reporting said insufficient quality of said video signal to said service provider comprises activating said signaling device.

3. The method of claim 2 wherein said signaling device comprises a button and wherein said step of activating said signaling device comprises the step of pushing said button.

4. The method of claim 1 wherein said video display control apparatus comprises a remote control unit, wherein said user interface used to report said insufficient quality of said video signal to said service provider comprises a signaling device mounted on said remote control unit, and wherein said step of reporting said insufficient quality of said video signal to said service provider comprises activating said signaling device.

5. The method of claim 4 wherein said signaling device comprises a button and wherein said step of activating said signaling device comprises the step of pushing said button.

6. The method of claim 4 wherein said remote control unit controls a set-top box.

7. The method of claim 4 wherein said remote control unit controls a television set with cable card capability and which has a cable card connected thereto.

8. The method of claim 1 wherein said step of reporting said insufficient quality of said video signal to said service provider comprises reporting a severity level associated with said insufficient quality of said video signal.

9. The method of claim 1 further comprising the step of performing an interactive troubleshooting procedure, wherein said interactive troubleshooting procedure comprises said customer providing one or more responses to a corresponding one or more questions relating to said insufficient quality of said video signal.

10. The method of claim 9 wherein said interactive troubleshooting procedure is implemented within a set-top box.

11. An apparatus for reporting video quality problems of video signals received at a customer premises of a customer of a video service provider, the apparatus located at the customer premises and comprising a video display control apparatus for receiving and displaying said video signals, the video display control apparatus including a user interface for use by said customer of said video service provider to initiate a report of insufficient quality of said video signal to said service provider.

12. The apparatus for reporting video quality problems of claim 11 wherein said video display control apparatus comprises a set-top box, wherein said user interface used to report said insufficient quality of said video signal to said service provider comprises a signaling device mounted on said set-top box, and wherein said reporting of said insufficient quality of said video signal to said service provider is performed by activating said signaling device.

13. The apparatus for reporting video quality problems of claim 12 wherein said signaling device comprises a button and wherein said activating of said signaling device is performed by pushing said button.

14. The apparatus for reporting video quality problems of claim 11 wherein said video display control apparatus comprises a remote control unit, wherein said user interface used to report said insufficient quality of said video signal to said service provider comprises a signaling device mounted on said remote control unit, and wherein said reporting of said insufficient quality of said video signal to said service provider is performed by activating said signaling device.

15. The apparatus for reporting video quality problems of claim 14 wherein said signaling device comprises a button and wherein said activating of said signaling device is performed by pushing said button.

16. The apparatus for reporting video quality problems of claim 14 wherein said remote control unit controls a set-top box.

17. The apparatus for reporting video quality problems of claim 14 wherein said remote control unit controls a television set with cable card capability and which has a cable card connected thereto.

18. The apparatus for reporting video quality problems of claim 11 wherein said reporting of said insufficient quality of said video signal to said service provider includes reporting a severity level associated with said insufficient quality of said video signal.

19. The apparatus for reporting video quality problems of claim 11 further comprising means for performing an interactive troubleshooting procedure, wherein said interactive troubleshooting procedure comprises said customer providing one or more responses to a corresponding one or more questions relating to said insufficient quality of said video signal.

20. The apparatus for reporting video quality problems of claim 19 wherein said means for performing said interactive troubleshooting procedure is comprised within a set-top box.
